(19) United States
(12) Patent Application Publication
(10) Pub. No.: US 2006/0059673 A1
(43) Pub. Date: Mar. 23, 2006

(54) Apparatus for moving production devices

(75) Inventors: Chun-Nan Ou, Tu-Cheng (TW); Chao-Guo Liu, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/219,449

(22) Filed: Sep. 2, 2005

(30) Foreign Application Priority Data
Sep. 22, 2004 (CN) 200420088766.1

(51) Int. Cl. B25B 27/14

(52) U.S. Cl. 29/281.5; 29/468

(57) ABSTRACT

An apparatus for moving and positioning a production device includes a fixing plate for fixing the production device, a trailer, a plurality of supports, and a supporting base. The trailer includes two bearing arms, and a transmission apparatus for lifting up or lowering the bearing arms. Each of the support includes a plurality of balls, disposed on a top surface of the support, and the balls define a supporting plane for supporting said production device. The supporting base supports a bottom of the production device, and includes two supporting wings on two sides thereof, and a plurality of positioning pins fixed to an underside thereof. The fixing plate includes a plurality of positioning sleeves matching with the positioning pins of the supporting base.

### BACKGROUND OF THE INVENTION

1. Field of the Invention

The invention relates to positioning apparatuses, and particularly relates to an apparatus for moving and positioning production devices.

2. Related Art

On conventional production lines, production devices like robots on each work station are immovably fixed by bolts. A fixing plate having screw holes is installed on or under the floor of each workstation. A robot is placed on the fixing plate, and the bolts are extended through holes in the robot into corresponding screw holes in the fixing plate. The robot is thus fixed in place. If the workstations on the production lines are changed, auxiliary tools, such as screwdrivers, lifting devices, and/or trailers are needed to remove the robots and/or move the robots to new workstations. Typically, when moving one of the robots, the robot is first lifted on the trailer. The trailer is then moved to a new workstation for installation of the robot. When re-fixing the robot, the holes of the robot should be corresponded to screw holes in the fixing plate of the new workstation. However, the robot is generally very heavy, and it is rather inconvenient to align the holes of the robot with the screw holes of the fixing plate. For avoiding said inconvenience, many robots may be left idle on production lines instead of being moved and utilized at new workstations, which results in under-utilization of resources and inefficient production.

Further, the above-described means for moving the robots takes time. It is desirable that a robot can be quickly removed when the production line does not need the robot, thereby providing valuable shop floor space. Similarly, it is desirable that the robot can be quickly re-installed when the production line needs the robot.

Therefore, a heretofore unaddressed need exists in the industry to address the aforementioned deficiencies and inadequacies.

### SUMMARY

Embodiments of the present invention provide an apparatus for moving and positioning a production device. The apparatus comprises a fixing plate, a trailer, a plurality of supports, and a supporting base. The fixing plate fixes the production device. The trailer for moving and positioning the production device comprises two bearing arms extending horizontally, which can be lift up or lowered. Each support comprises a plurality of balls, disposed on a top thereof, and the balls define a supporting plane for supporting the production device. The supporting base, fixed to a bottom of the production device, comprises two supporting wings on two sides, and a plurality of positioning pins, fixed to an underside thereof. The fixing plate further comprises a plurality of positioning sleeves matching with the positioning pins of the supporting base.

Other advantages and novel features will be or become more apparent to one with skill in the art upon examination of the following detailed description of preferred embodiments when taken in conjunction with the accompanying drawings, in which:

### BRIEF DESCRIPTION OF THE DRAWINGS

FIG. 1 is an exploded, isometric view of parts of an apparatus for moving and positioning a production device in accordance with a preferred embodiment of the present invention, the apparatus comprising a trailer, a pair of supports, and a fixing plate embedded in a factory floor, a supporting base of the apparatus not being shown;

FIG. 2 is an enlarged, exploded, isometric view of one of the supports of the apparatus of FIG. 1;

FIG. 3 is an exploded, isometric view of a typical production device used in conjunction with the apparatus of FIG. 1, and the supporting base of the apparatus;

FIG. 4 is an isometric view of the robot of FIG. 3 being loaded onto the trailer of FIG. 1, prior to the trailer being moved along the factory floor toward the fixing plate; and

FIG. 5 is similar to FIG. 4, but showing the trailer fixed to the fixing plate.

### DETAILED DESCRIPTION OF PREFERRED EMBODIMENTS

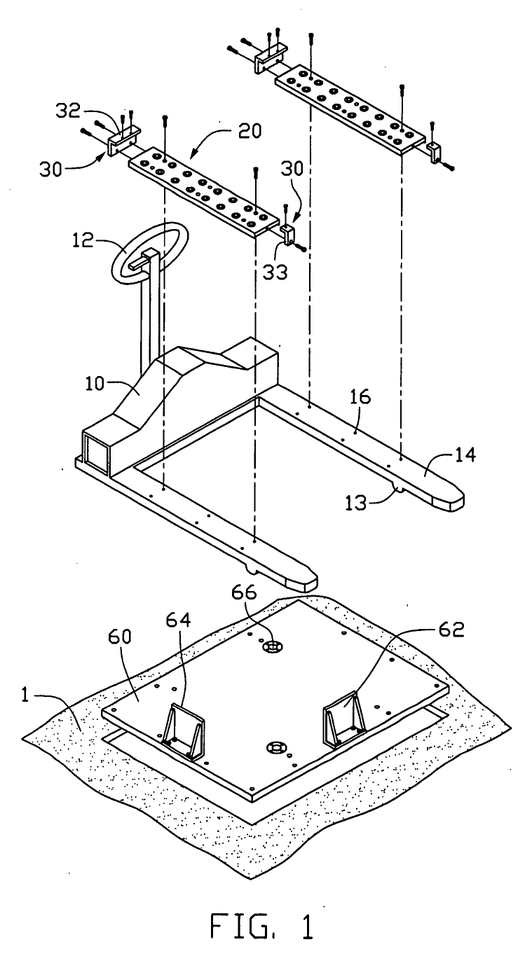

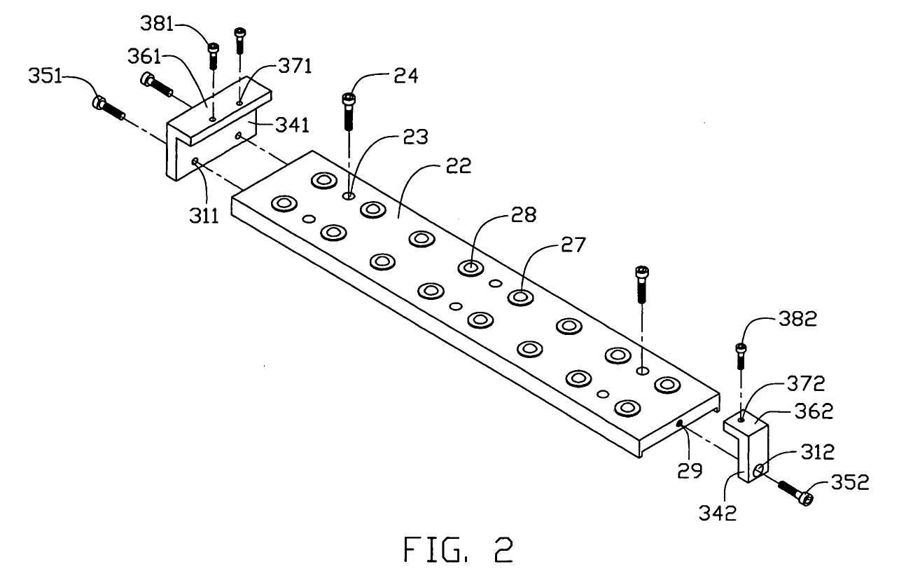

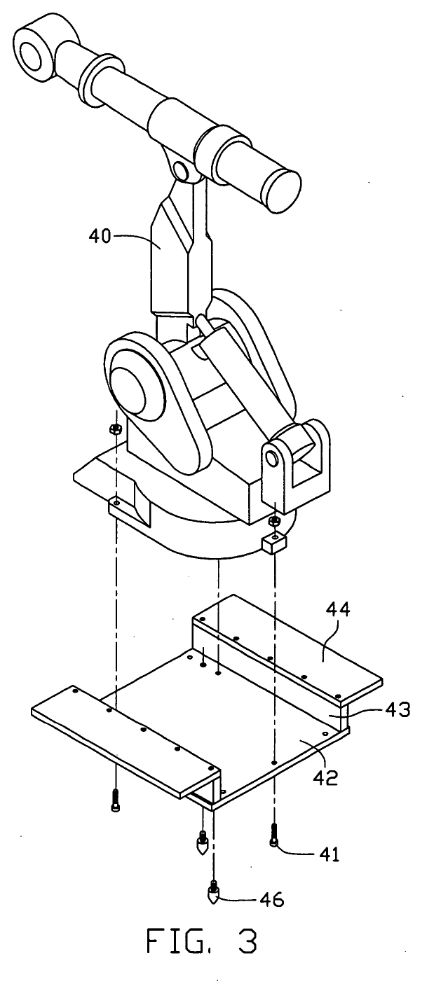

Referring to FIGS. 1, 2, and 3, an apparatus for moving a production device according to an embodiment of the present invention comprises a trailer 10 (see FIG. 1) used as a moving mechanism, a pair of supports 20 (one of the supports particularly shown in FIG. 2), a pair of adjusting apparatuses 30 attached to the supports 20 respectively, a supporting base 42 (FIG. 3), and a fixing plate 60. In the embodiment, the trailer 10 is a hydraulic lifting trailer. In the following description and drawings, the production device described is a robot 40 as shown in FIG. 3, for the purposes of exemplary illustration of the preferred embodiments.

The support 20 and the adjusting apparatus 30 are fixed on the trailer 10, the supporting base 42 is provided to fix to a bottom of the robot 40, which is defined by a weight direction of the robot 40, and the fixing plate 60 is embedded in a factory floor 1.

Referring to FIG. 1, the trailer 10 comprises a handle 12 for operating a transmission apparatus (not shown), and two horizontal bearing arms 14 supported by a plurality of blocks 13. By operating the handle 12 of the trailer 10, the bearing arms 14 are driven to lift up a load such as the robot 40. By releasing the handle 12, the bearing arms 14 are lowered. Each of the bearing arms 14 comprises a plurality of screw holes 16.

The robot 40 is placed on the trailer 10, and the bottom of the robot 40 is fixed on the supporting base 42 by bolts 41, as shown in FIG. 3. Two sides of the supporting base 42 extend upward to form two sidewalls 43. The sidewalls 43 and the supporting base 42 cooperatively form a substantially rectangular receiving space. Additionally, each of the sidewalls 43 horizontally extends outwardly and forms a supporting wing 44.

The adjusting apparatuses 30 connect corresponding supports 20 and the bearing arms 14 of the trailer 10. The supports 20 comprise a plurality of balls 28, disposed on a top surface thereof. Moreover, as shown in FIG. 2, each support 20 comprises a connecting panel 22. The connecting panel 22 has a plurality of hollow holes 23 defined thereon, corresponding to the screw holes 16 of the bearing arm 14. A plurality of bolts 24 extend through the hollow holes 23, and are engaged therewith, thereby securing the connecting panel 22 to the bearing arms 14. A plurality of receiving recesses 27 are defined on a top surface of the connecting panel 22, each receiving recess 27 containing a ball 28 therein. In the embodiment, a diameter of the ball 28 is substantially larger than a depth of the receiving recess 27. Thus, tops of the balls 28 protrude from the top surface of the connecting panel 22. The balls 28 cooperatively define a supporting plane, substantially spaced from the top surface of the connecting panel 22, for supporting the robot 40. The robot 40 can be slid on the trailer 10 by rotation of the balls 28. In the embodiment, a pair of screw holes 29 are defined on a first end of the connecting panel 22 and correspond to the handle 12. A single screw hole 29 is defined on an opposite second end of the connecting panel 22.

In the embodiment, each adjusting apparatus 30 comprises a first retainer 32 and a pair of first adjusting bolts 381, and a second retainer 33 and a second adjusting bolt 382. The first retainer 32 and the second retainer 33 correspond to each other. The first retainer 32 is fixed to the first end of the connecting panel 22 via a pair of bolts 351, and the second retainer 33 is fixed to the second end of the connecting panel 22 via a single bolt 352. In another embodiment, the first retainer 32 may be integrally formed with the first end of the connecting panel 22, and/or the second retainer 33 may be integrally formed with the second end of the connecting panel 22.

According to the embodiment, the second retainers 33 are provided in addition to the first retainers 32, when the first retainers 32 cannot provide enough retaining force for retaining the robot 40. In an alternative embodiment, the adjusting apparatus 30 may comprise only the first retainers 32, without the second retainers 33.

The first retainer 32 and the second retainer 33 respectively comprises bodies 341 and 342 with adjusting parts 361 and 362 extending perpendicularly from the bodies 341 and 342. The adjusting parts 361 and 362 have screw holes 371 and 372 respectively defined thereon, the screw holes 371 and 372 respectively matching with the first adjusting bolts 381 and the second adjusting bolt 382. In the embodiment, a height of the bodies 341 and 342 is substantially greater than a thickness of the supporting wings 44 of the supporting base 42. The bodies 341 and 342 respectively define fixing holes 311 and 312, respectively corresponding to the screw holes 29 of the first and second ends of the connecting panel 22.

In the embodiment, the fixing plate 60 is embedded in the factory floor 1, and the trailer 10 is readily slid on the fixing plate 60. Power supply and control circuits are provided on the factory floor 1, for powering and controlling the robot 40. Each of two neighboring sides of the fixing plate 60 has a stop 62 fixed thereon and having a positioning face 64. The positioning faces 64 of the two stops 62 have a fixing corner, accurately positioning the trailer 10 loaded with the robot 40. A pair of positioning sleeves 66 are embedded on a top surface of the fixing plate 60, receiving a pair of pins 46 fixed to an underside of the supporting base 42.

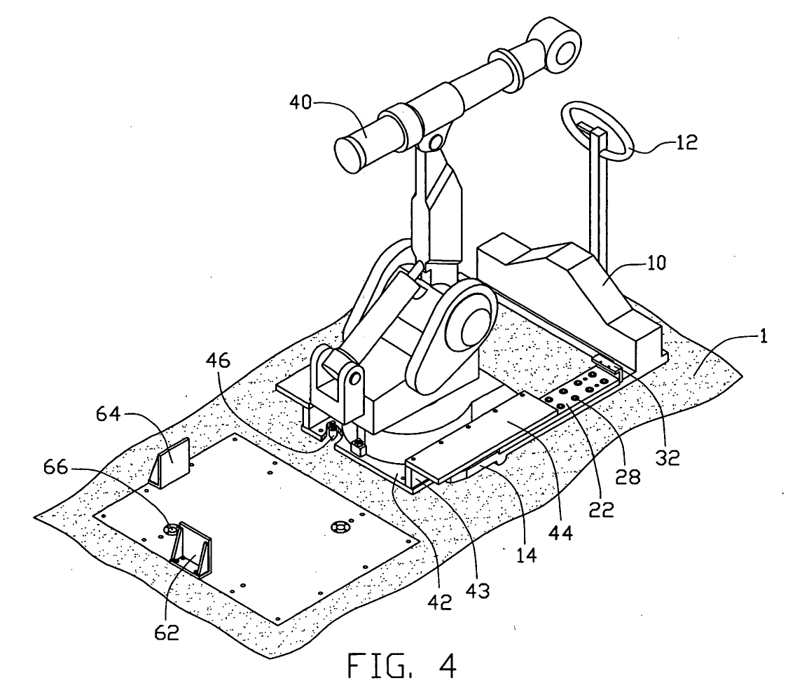

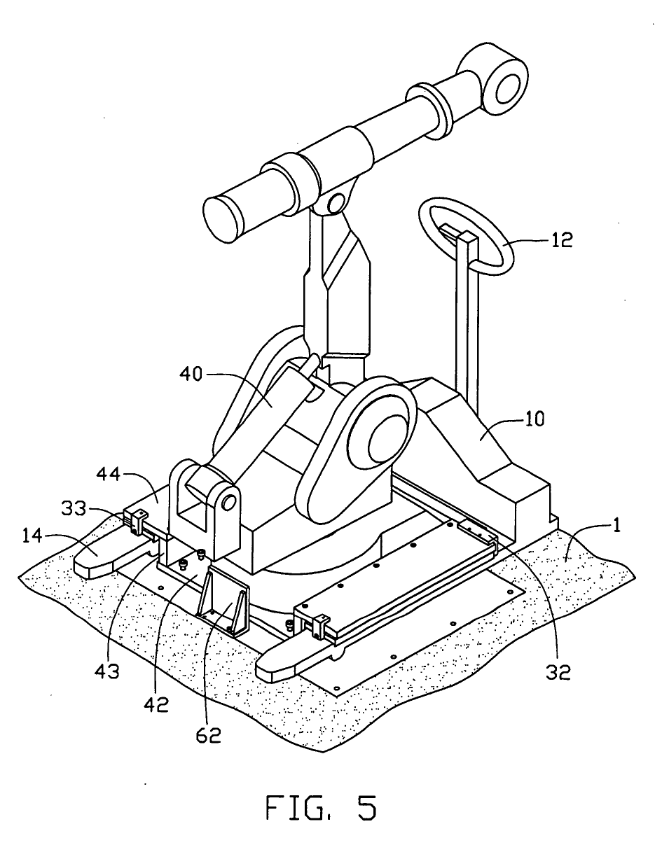

Referring also to FIGS. 4 and 5, the supporting base 42 is fixed to the robot 40 by use of the bolts 41. The connecting panels 22 of the supports 20 are fixed onto the bearing arms 14 of the trailer 10 by the bolts 24, with the receiving grooves 26 containing the balls 28. For each adjusting apparatus 30, the bolts 351 are extended through the fixing holes 311 and engaged with the corresponding screw holes 29, thereby fixing the retainer 32 to the first end of the connecting panel 22.

In the present embodiment, the bearing arms 14 of the trailer 10 can be inserted under the supporting wings 44 of the supporting base 42. By operating the handle 12, the transmission apparatus of the trailer 10 can lift the bearing arms 14 until the balls 28 of the supports 20 abut against the supporting wings 44. When the bearing arms 14 are lifted further, the robot 40 is fully supported on the balls 28.

The first adjusting bolts 381 of the first retainers 32 are screwed down to press on the supporting wings 44 of the supporting base 42. In the embodiment, the second retainers 33 are provided for exerting more retaining force when the robot 40 is supported on the trailer 10. The bolts 352 extend through the fixing holes 312 and are engaged with the corresponding screw holes 29, thereby fixing the second retainers 33 to the second ends of the connecting panels 22. The height of the bodies 342 of the second retainers 33 is substantially greater than the thickness of the supporting wing 44 of the supporting base 42. Thus, the adjusting parts 362 extending from the bodies 342 are located above the supporting wings 44. The second adjusting bolts 382 are screwed down to press on the supporting wings 44 of the supporting base 42, thereby retaining the robot 40 on the trailer 10.

Subsequently, the trailer 10 with the robot 40 thereon is moved to a designated position on the fixing plate 60 at a new workstation. The trailer 10 abuts against the positioning faces 64 of the stops 62. In this position, each of the positioning pins 46 of the supporting base 42 is positioned directly above each of the positioning sleeves 66. The transmission apparatus of the trailer 10 is released, the bearing arms 14 descend, and the positioning pins 46 are engaged with the positioning sleeves 66. Thus, the robot 40 is accurately positioned on the fixing plate 60. By releasing the second adjusting bolts 382,the second retainers 33 are removed from the second ends of the connecting panels 22. Finally, by releasing the first adjusting bolts 381,the trailer 10 is removed from the supporting base 42. In this manner, the robot 40 can be moved from one workstation to another workstation.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

We claim:

1. An apparatus for moving and positioning a production device, comprising:
a fixing plate for fixing the production device;
a trailer, for moving the production device, comprising two bearing arms extending horizontally and a transmission apparatus for lifting up or lowering the bearing arms;
a plurality of supports, each comprising a plurality of balls, disposed on a top surface of the support, and the balls defining a supporting plane for supporting the production device; and
a supporting base for supporting a bottom of the production device, the supporting base comprising two supporting wings on two sides thereof, and a plurality of positioning pins fixed to an underside thereof;
wherein the fixing plate comprises a plurality of positioning sleeves matching with the positioning pins of the supporting base.

2. The apparatus as recited in claim 1, wherein the trailer further comprises a handle for operating the transmission apparatus.

3. The apparatus as recited in claim 1, wherein each support comprises a plurality of receiving recesses for receiving the balls.

4. The apparatus as recited in claim 1, further comprising a plurality of adjusting apparatuses, connecting the corresponding supports and the bearing arms.

5. The apparatus as recited in claim 4, wherein each adjusting apparatus comprises two retainers, each comprising a body and an adjusting part extending perpendicularly from the body.

6. The apparatus as recited in claim 5, wherein each support comprises a connecting panel, and the two retainers are respectively fixed to two ends of the connecting panel.

7. The apparatus as recited in claim 5, wherein each adjusting part comprises at least one adjusting bolt.

8. The apparatus as recited in claim 7, wherein each adjusting part comprises at least one screw hole for receiving the at least one adjusting bolt.

9. The apparatus as recited in claim 8, wherein the fixing plate comprises a stop fixed thereon.

10. The apparatus as recited in claim 9, wherein the stop has a positioning face for stopping and positioning the trailer.

11. An apparatus for moving and positioning a production device, comprising:
a fixing means for fixing the production device;
a trailing means for moving the production device, the trailing means comprising two bearing arms extending horizontally and a transmission apparatus for lifting up or lowering the bearing arms;
a supporting means comprising a plurality of balls, defining a supporting plane for supporting the production device;
an adjusting apparatus, connecting the corresponding supporting means and the bearing arms of the trailing means; and
a base means for supporting a bottom of the production device, two sides of the base means extending to respectively form a supporting wing, and the base means including a plurality of positioning pins;
wherein the fixing means comprises a plurality of positioning sleeves matching with the positioning pins of the base means.

12. A method to move and position a production device, comprising the steps of:
forming at least one supporting wing connectively extending and offset from a bottom of said production device defined by a weight direction of said production device so as to provide a space adjacent to said production device and said at least one supporting wing;
defining a first and a second fixing plate to locate said production device;
placing said production device onto said first fixing plate along said weight direction of said production device;
firmly positioning said production device by means of engagement of said bottom and said first fixing plate wherein said engagement is removable exclusively along a reverse direction of said weight direction;
introducing a moving mechanism into said space adjacent to said at least one supporting wing along another direction different from said weight direction and said reverse direction;
lifting said production device along said reverse direction by means of engagement of said at least one supporting wing and said moving mechanism so as to disengage said bottom from said first fixing plate for moving said production device to said second fixing plate; and
repeating said placing and positioning steps to position said production device onto said second fixing plate when said production device is moved to said second fixing plate by said moving mechanism.

13. The method as recited in claim 12, wherein a supporting base is defined along said bottom of said production device, and said at least one supporting wing extends and is offset from said supporting base.
